(19) United States
(12) Patent Application Publication
(10) Pub. No.: US 2024/0384009 A1
(43) Pub. Date: Nov. 21, 2024

(54) METHOD FOR PRODUCING SURFACE MODIFIED NANOCELLULOSE MATERIAL

(71) Applicant: THE COURT OF EDINBURGH NAPIER UNIVERSITY, Edinburgh, Lothian (GB)

(72) Inventors: Amaka J. ONYIANTA, Mangotsfield, Bristol (GB); Dominic Francis O'ROUKE, Dundee, Angus (GB); Mark DORRIS, Strathaven, South Lanarkshire (GB)

(21) Appl. No.: 18/833,792

(22) PCT Filed: Feb. 3, 2023
(86) PCT No.: PCT/GB2023/050251

§ 371 Date: Jul. 26, 2024

(30) Foreign Application Priority Data
Apr. 2, 2022 (GB) 2201451.8

(51) Int. Cl. C08B 15/02

(52) U.S. Cl. CPC C08B 15/02

(57) ABSTRACT

A method for producing surface modified nanocellulose material is described comprising: (i) providing a mixture of an organic acid and at least one solvent; (ii) providing a fibrous cellulosic material is an unprocessed form: (iii) suspending the fibrous cellulosic material in the mixture of the organic acid at a temperature of less than 100° C. to form a suspension; (iv) maintaining the suspension for a period of time to provide a surface modified fibrous cellulose material; and (v) passing the suspension through at least one chamber having a large gap, at a high shear to produce surface modified cellulose nanofibrils, wherein the organic acid is a dicarboxylic acid, a tricarboxylic acid or a mixture thereof. Also described are surface modified cellulose nanofibrils, surface modified nanocrystals and uses of the same.

### TECHNICAL FIELD

The present invention relates to a method for producing surface modified nanocellulose material using organic acids and lower temperatures than are typical in the art. The invention also relates to cellulose nanofibrils resulting from such method, cellulose nanocrystals and use of the resulting nanocellulose material.

### BACKGROUND OF THE INVENTION

The food, household and personal care industries are particularly under pressure to replace unpleasant materials, which have the potential to negatively impact human/animal health and the environment, with more environmentally benign materials from renewable and sustainable sources. Cellulose ticks the boxes of a renewable, sustainable, biodegradable and biocompatible material for a wide range of such applications.

Cellulose is derived from bacteria, algae and higher plants, i.e. land plants with lignified tissues for transporting water and minerals through the plant. Most commercial production of cellulose is derived from wood pulp, often as a by-product of the paper industry.

In order for cellulose to function effectively in many formulations and applications, it may require surface functionalisation. Cellulose esterification, etherification and oxidation are methods that have been used to create some of the commercially available cellulose derivatives.

Cellulosic material which consists of at least one dimension in the range of less than 1 micron, typically less than 500 nm, is known as nanocellulose.

Examples of nanocellulose include microcrystalline cellulose (MMC), cellulose microfibrils (CMF), microfibrillated cellulose (MFC and NFC), cellulose nanofibrils (CNF) and cellulose nanocrystals (CNC). Cellulose nanofibrils are the smallest type of cellulose still in fibril state and cellulose nanocrystals are the smallest type of cellulose available (typically 100 s to 1000 nanometers) and are highly crystalline and rigid nanoparticles. CNF has a high aspect ratio (length to width ratio) and typically have widths of 5 to 20 nanometers and a wide range of lengths, typically of several micrometers, although widths in the range of 4 to 100 nm have been reported in the art, specifically where CNF exists in localised bundles. Such CNF and CNC nanocellulose provide advantageous properties for use in a wide range of food, household and personal care applications.

Surface modification has been applied to cellulose derivatives including nanocellulose to enhance fibrillation and increase functionality. This improves various material properties, such as transparency, high viscoelasticity, and improved mechanical strength. Surface modification of nanocellulose is also used to tune the material into active sites that can bind to other materials with complementary charges, such as seen in dye and metal recovery from wastewater and for the immobilisation of enzymes, proteins and active pharmaceutical ingredients (API).

Irrespective of the widened spectrum of applications opened up by surface modification of cellulose and its nanomaterial counterpart, some of these methods continue to make use of large amount of chemicals that are neither cost-effective nor sustainable. Attempts have been made to reduce the environmental impacts of the carboxymethylation and TEMPO-mediated oxidation processes by reducing the amounts of solvents and the possibility of solvent recycling and reuse. Other attempts have focused on the use of greener organic acids for concurrent surface modification and hydrolysis. In particular, such methods form nanocellulose by acid hydrolysis (with sulphuric and hydrochloric acids) and then modify the nanocellulose (a mixture of cellulose nanofibrils and nanocrystals) with the organic acid at room temperature for 12 hours in the presence of a sodium hypophosphite catalyst. However, the quality of the modified products relies upon the initial quality of the nanocellulose used.

Organic acids are biobased mono-, di-or trifunctional acid containing organic compounds such as acetic acid, formic acid, malonic acid, oxalic acid and citric acid. This group of acids are preferred over inorganic acids and have been used for concurrent esterification and hydrolysis of cellulose materials to produce cellulose nanocrystals via the Fisher esterification method using hydrochloric acid as catalyst.

Cellulose modified with citric acid in low and very high concentration have been portrayed as good adsorbent for copper ions. One particular method subjects cellulose acetate to fibre-spinning and deacetylation before citric acid modification at 140° C. for 30 minutes to provide a product which is a spun-fibre network. Indeed, typical known methods are centred on the preparation of carboxylated cellulose or cellulose nanocrystals and as such requires high temperatures between 100° C. to 140° C. Very few studies have focused on the preparation and of high quality cellulose nanofibrils by citric acid modification.

Ji et al., (2019), Green Chemistry, 21(8), 1956-1964, and Liu et al., (2017), Paper and Biomaterials, 2(4), 19-27, reported that CNF was obtained as a by-product of high temperature citric acid hydrolysis of sugarcane bagasse pulp and softwood wood pulp to produce cellulose nanocrystals (CNC). However, this research was aimed at using high temperature hydrolysis to drive chemical processing in order to achieve the intended carboxylated CNC product.

Citric acid is a non-noxious chemical and has great potential for the modification of cellulose because it can be recycled and reused. However, existing methods which use citric acid require high temperatures (up to 140° C.) which impact negatively on the total energy demand for nanocellulose production.

Accordingly, there exists a need to provide a more cost efficient and sustainable method for producing surface modified nanocellulose materials, including cellulose nanofibrils and cellulose nanocrystals.

### SUMMARY OF THE INVENTION

In accordance with one aspect of the invention, there is provided a method for producing surface modified nanocellulose material comprising:
i) providing a mixture of an organic acid and at least one solvent;
ii) providing a fibrous cellulosic material is an unprocessed form;
iii) suspending the fibrous cellulosic material in the mixture of the organic acid at a temperature of less than 100° C. to form a suspension;
iv) maintaining the suspension for a period of time to provide a surface modified fibrous cellulose material; and
v) passing the suspension through at least one chamber having a large gap, at a high shear to produce surface modified cellulose nanofibrils
wherein the organic acid is a dicarboxylic acid, a tricarboxylic acid or a mixture thereof.

It has surprisingly been found that subjecting fibrous cellulosic material to surface modification with a dicarboxylic acid and/or a tricarboxylic acid at reduced reaction temperatures and subsequently processing via high shear homogenization results in surface modified cellulose nanofibrils functionalized for a wide range of applications. In particular, it is surprising that the fibrous cellulosic materials were successfully modified at reduced temperatures as higher reaction temperatures are favoured in the art for improved reactivity.

In contrast to surface modification methods using formic acid known in the art, which provides a heterogeneous nanocellulose product (predominantly comprising cellulose nanocrystals) irreversibly surface modified with ester groups, surface modification with the dicarboxylic acids and/or tricarboxylic acids according to the present invention results in a highly homogeneous cellulose nanofibril product modified with carboxyl groups. The resulting material is highly hydrophilic which disperses in water and may provide a basis for further modification including acid hydrolysis to form a more homogeneous surface modified CNC product. Therefore, the surface modified CNF is a versatile product ready for use in a wide range of applications. Further, the use of dicarboxylic acids and/or tricarboxylic acids enables a higher degree of surface modification, thus providing a more highly surface modified CNF product.

In addition, the use of high shear homogenization provides less aggressive handling and processing conditions, namely processing in water in less intense conditions, through at least one chamber with a larger gap for one or more passes, enabling a simplified procedure for processing surface modified fibrous cellulosic material into cellulose nanofibrils. In addition, surface modification of cellulose with dicarboxylic and/or tricarboxylic acids is an attractive way of retaining the sustainability profile of cellulose nanofibrils. The dicarboxylic and tricarboxylic acids also provide the advantage of being recyclable and so may be reused in subsequent surface modification reactions.

Consequently, the method of the present invention provides a sustainable, cost efficient, direct reaction scheme for producing surface modified cellulose nanofibrils.

The resulting nanocellulose is a homogenous product consisting of discrete surface modified cellulose nanofibrils, which are amenable to acid hydrolysis to form surface modified nanocrystals. The properties of the resulting surface modified nanocellulose materials are at least comparable with material made by known methods but provide the advantages of superior sustainability, more cost efficient and more environmentally friendly methods of production. In particular, the storage modulus of the surface modified cellulose nanofibrils compared well with the industry standard carboxymethylation process. The modification process also improves the transparency and the crystallinity of the nanocellulose materials, while insignificantly affecting the thermal properties. Consequently, the surface modified cellulose nanofibrils are capable of suspending the insoluble particles in solution, preventing their sedimentation, thus being suitable for use as rheology modifiers for the drug and personal care industries and other industries that require fluid structuring.

In addition, the resulting nanocellulose exhibits superabsorbent properties when dried and so may find applications in many home and personal care products, including but not limited to paper towels, nappies and sanitary products. Further, the absorbent properties of the surface modified cellulose nanofibrils can find application in the absorption of copper ions for making electroconductive cellulose membranes for battery separators.

By “unprocessed form” it is meant that the cellulosic fibrous material is not subjected to any pre-treatments to aid processing of the cellulose nanofibrils such as mechanical milling or grinding or the use of enzymatic, swelling, hydrolytic or oxidation agents prior to suspending in water, as are required in the art. However, this does not preclude prior extraction of the cellulose fibrous materials from its original source material, for example the cellulosic fibrous materials being by-products of the alginate or paper industries, as discussed below.

The method may further comprise the steps of:
washing the surface modified fibrous cellulose material in water after step (iv) to achieve a washed surface modified fibrous cellulose material with a neutral pH; and
suspending the surface modified fibrous cellulosic material in water to form a second suspension;
   wherein the suspension passed through the at least one chamber in step (v) is the second suspension.

The method may further comprise the steps of:
suspending the washed surface modified fibrous cellulose material in an alkali salt solution to form a further suspension;
maintaining the further suspension for a period of time; and
washing the surface modified fibrous cellulose material in water to achieve a neutral pH
   prior to the step of suspending the surface modified fibrous cellulosic material in water to form the second suspension.

The resulting nanocellulose material of the method including these additional steps is an alkali salt form of the surface modified nanocellulose, which may be favoured in various applications. For example, the alkali salt form, such as the sodium form, is in a higher charged state and the charge opens up the fibrils more extensively for rheological modification. In other applications, the alkali salt form can essentially maintain stability of the product and can be readily removed for further modification of the carboxylate ion, for example for hydrophobic modification.

In such an embodiment, the alkali salt of the alkali salt solution may be sodium bicarbonate, sodium carbonate, sodium chloride, sodium hydroxide, potassium bicarbonate, potassium carbonate, potassium chloride, potassium hydroxide, or a mixture thereof. For example, the alkali salt may be sodium bicarbonate.

The further suspension may be maintained for a period of 10 minutes to 5 hours, for example, 15 minutes to 4 hours, 30 minutes to 3 hours and 45 minutes to 2 hours, 60 to 90 minutes or 1 hour.

The fibrous cellulosic material may be suspended in the mixture of the organic acid at a temperature within the range of from 50° C. to 95° C., for example 60° C. to 90° C. In some embodiments, the temperature may be within the range of from 65° C. to 85° C. or less than 80° C.

The organic acid is a dicarboxylic acid, a tricarboxylic acid or a mixture thereof, i.e. the organic acid may be any organic carboxylic acid whose chemical structure contains two or three carboxyl functional groups (—COOH). The greater number of carboxylic acid functional groups in such acids is preferable to achieve a greater extent of carboxylation in the surface modified product. The dicarboxylic acids and/or tricarboxylic acids may be selected depending upon their readiness to disperse in the at least one solvent selected. For example, short and linear dicarboxylic acids and/or tricarboxylic acids may be selected where the solvent is water as they disperse more readily in water.

The organic acid may be selected from the group consisting of oxalic acid, malic acid, malonic acid, succinic acid, tartaric acid, glutaric acid, citric acid, isocitric acid, aconitic acid, propane-1,2,3-tricarboxylic acid, agaric acid, trimesic acid, or any combination thereof. For example, oxalic acid, malic acid, malonic acid, succinic acid, tartaric acid, glutaric acid, citric acid, isocitric acid and/or aconitic acid may be favoured due to their short chain length and linear structure. In some embodiments, the organic acid may be a tricarboxylic acid, for example citric acid.

The tricarboxylic acid, citric acid, may be favoured due to its tricarboxylic acid moiety, cost-effectiveness and acceptance within the food and cosmetics industries. It also has a positive green indication as it can be sourced from a photosynthetically renewable material.

The organic acid may be essentially soluble in the at least one solvent. The at least one solvent is water, methanol, ethanol, isopropanol, tert-butanol, isobutanol, butan-2-ol, acetone, dimethyl sulfoxide (DMSO), dimethylacetaminde (DMAC), dimethylformamide (DMF), or a mixture thereof.

The mixture of the organic acid and at least one solvent may consist only of the organic acid (i.e. a dicarboxylic acid, a tricarboxylic acid or a mixture thereof) and at least one solvent selected from water, methanol, ethanol, isopropanol, tert-butanol, isobutanol, butan-2-ol acetone, dimethyl sulfoxide (DMSO), dimethylacetaminde (DMAC), dimethylformamide (DMF), or a mixture thereof.

The suspension may be maintained for a period of from 10 minutes to 10 hours, for example, 20 minutes to 8 hours, 30 minutes to 6 hours or 1 to 5 hours, for example, 4 hours.

The fibrous cellulosic material may be derived from algae, wood or water hyacinth. The fibrous cellulosic material is typically a by-product of other industries, such as alginate production, paper-making, high value chemical extraction for pharmaceuticals and nutraceuticals, and so in making use of the waste products of such processes, the present invention provides a green, zero waste process.

The term “algae” is intended to include all fibrous cellulose containing algae, including but not limited to microalgae and seaweed. The algae may be seaweed, for example brown, red and green macroalgae. Brown seaweed typically has a comparatively high cellulose content, for example Laminaria hyperborea comprises 10 to 12% cellulose which is present in the by-product of the extraction of alginate.

Sargassum is another potentially useful brown seaweed. The cellulose content of brown seaweed is higher than in other algae and so may provide one suitable starting material for the present invention. However, it is appreciated that the fibrous cellulosic material may alternatively be red algae which comprises cellulose to a lesser extent to brown seaweed.

Alternatively, the fibrous cellulosic material may be derived from wood, in particular from wood pulp, which is a by-product of the paper industry. The cellulose content of wood pulp is typically in the range of 40 to 45%. Therefore, wood pulp provides a further suitable starting material to produce high quantities of surface modified cellulose nanofibrils and cellulose nanocrystals. However, the resulting surface modified cellulose nanofibrils may be shorter in length.

Water hyacinth provides a further alternative source of fibrous cellulosic material, having a high cellulose content of approximately 25% and a low lignin content.

The surface modified fibrous cellulosic material may be suspended in water at a concentration of from 0.5 to 5% by weight.

The method of the present invention enables higher concentrations of fibrous cellulose material to be processed. For example, the fibrous cellulosic material may be suspended in water in a concentration up to 5% by weight. As will be appreciated, the inherent rheological properties of the material are a limiting factor to the concentration in water and so the concentration may be selected to ensure that the resulting suspension is not too viscous. For example, a concentration in the range of 0.5 to 5% by weight may be used. Alternatively, concentrations of 0.5 to 4% by weight or 1 to 3% by weight may be used. Concentrations less than 0.5% by weight are of course possible, for example, very low concentrations of 0.1 wt % and 0.2 wt % may be processed this way including with some wood derived cellulose materials. However, the process may not be commercially viable at such low concentrations.

The at least one chamber may be any suitable configuration, for example, Z or Y shaped or straight as per auxiliary chambers. For example, the at least one chamber may be an interaction chamber and/or an auxiliary chamber.

The suspension passes through the at least one gap into the at least one chamber for processing therein. The at least one gap may be 70 micron or greater, for example, from 70 micron to 250 microns. If at least one chamber having a larger sized gap (i.e. up to 250 microns) is employed, the suspension may be required to undergo multiple passes through the chamber (for example, up to 7) in order to achieve a highly homogeneous product. However, where at least one chamber having a gap of 100 microns is employed, a similarly pure product may be achieved with one pass through the chamber. Therefore, the gap size may be selected accordingly, although it is appreciated that processing down time may be increased if a smaller size gap is used due to blockages. In one or more embodiments, the at least one chamber incorporating a single gap may be used.

The suspension may undergo a single pass through the at least one chamber having a large gap. For example, a single pass for a suspension of surface modified cellulosic material derived from algae is sufficient to provide improved rheological properties. Alternatively, the suspension may undergo multiple passes through the at least one chamber having a large gap. The suspension may undergo from 1 to 7passes through the at least one chamber having a large gap, at a high shear. The number of passes may depend upon the source of the fibrous cellulosic starting material and/or the desired properties or use of the resulting surface modified nanocellulose material. For example, 1 or 2 passes may be favoured for surface modified fibrous cellulosic material derived from algae, while 3 to 5 passes may be favoured for surface modified fibrous cellulosic material derived from wood pulp.

The suspension may be passed through the at least one chamber at a comparatively low pressure compared to known high shear nanocellulose processing. Typically, the suspension may be passed through the at least one chamber at a pressure up to 200 MPa. For example, pressures of up to 140 MPa may be used for a chamber having a 200 micron gap, whereas pressures of up to 200 MPa may be used for a chamber having a gap of 70 to 100 microns.

Processing of the surface modified cellulosic fibrous material to surface modified nanofibrils may be achieved via the method of the present invention consisting only of the steps described above, in the order described above. Indeed, high quality surface modified cellulose nanofibrils in high yields may readily be achieved with only a single chamber as described above. However, in some situations, multiple chambers may be employed.

The method may further comprise the step of drying the surface modified cellulose nanofibrils to produce surface modified cellulose nanofibrils in a dry form. This may be achieved by any suitable means in the art, for example, freeze drying, spray drying, supercritical drying or by evaporation through solvent exchange into acetone, isopropanol or tert-butanol in a first step. However, any methods which leads to agglomeration, such as air drying in a hot oven, should be avoided.

The mechanical processing step (step v) of the method of the present invention may be carried out in a high shear homogeniser. Any commercially available high shear homogeniser may be adapted to carry out this processing.

The method of the present invention may further comprise subjecting the surface modified cellulose nanofibrils to acid hydrolysis to form surface modified cellulose nanocrystals.

Acid hydrolysis is a standard technique in the art for forming cellulose nanocrystals. However, it has been found that the surface modified cellulose nanofibrils formed by the present invention are more amenable to acid hydrolysis than CNF from other sources. Consequently, the resulting yield of cellulose nanocrystals is much higher than is typically observed in the art. Further, the resulting surface modified cellulose nanocrystals may be a high quality end product achievable at much lower cost.

As with the surface modified cellulose nanofibrils, the resulting surface modified cellulose nanocrystals are in an easily separable form, ready for use in a wide range of applications.

Acid hydrolysis may use hydrochloric acid, sulphuric acid, nitric acid, phosphoric acid or the like. In one or more embodiments, the acid hydrolysis may use hydrochloric acid, which may result in an increased yield of the surface modified cellulose nanocrystals.

In a second aspect of the present invention, there is provided cellulose nanofibrils having greater than 60% surface modification of active groups. The % surface modification may be measured by any suitable known analysis method, such as conductometric titration.

The surface modified cellulose nanofibrils of the present invention provide higher amount of surface modification over cellulose produced via known methods, which typically 30 to 40% modification or at most 40 to 60% modification. In some embodiments the surface modified cellulose nanofibrils of the present invention may have a surface modification of greater than 70%, for example 80 to 90%.

Commercially available material described as cellulose nanofibrils typically comprise a mixture of different sized fibrils and particles with an average size in the nanofibrils range. The surface modified cellulose nanofibrils formed by the method of the first aspect of the present invention are a higher quality homogeneous product with a much narrower size distribution within the nano range.

For example, the surface modified cellulose nanofibrils is a substantially homogeneous product. As a substantially homogeneous product, at least 95%, for example, at least 97% and in some cases, at least 99% of the surface modified cellulose nanofibrils exist as discrete entities each with two dimensions in the nano range.

The cellulose nanofibrils of the present invention may have one or more of the following properties:
a. a fibril width of from 4 to 100 nm, for example 5 to 50 nm, 5 to 35 nm or 15 to 25 nm;
b. a fibril aspect ratio of greater than 50, for example greater than 100 or at least 200;
c. a fibril length of at least 750 nm to greater than 1 mm;
d. a storage modulus of 100 to 2000 Pa, for example 300 to 1800 Pa; and
e. a transparency of greater than 70% at 600 nm, for example, greater than 80% or greater than 90%.

The cellulose nanofibrils of the present invention may have any combination of the above properties. For example, the cellulose nanaofibrils may have one or more of: a fibril width of from 15 to 25 nm; a fibril aspect ratio of greater than 100; a fibril length of at least 750 nm to greater than 1 mm; a storage modulus of 300 to 1800Pa; and a transparency of greater than 80% at 600 nm.

In one or more embodiments, the cellulose nanofibrils may have: a fibril width of from 4 to 100 nm, for example 5 to 50 nm, 5 to 35 nm or 15 to 25 nm; a fibril aspect ratio of greater than 50, for example greater than 100 or at least 200; a fibril length of at least 750 nm to greater than 1 mm; a storage modulus of 100 to 2000 Pa, for example 300 to 1800 Pa; and a transparency of greater than 70% at 600 nm, for example, greater than 80% or greater than 90%.

In a further aspects of the present invention, there are provided surface modified cellulose nanofibrils formed by the method of the first aspect and surface modified cellulose nanocrystals formed by the method of the first aspect.

The resulting surface modified nanocellulose material may be suitable for use in a wide range of applications. For example, the surface modified cellulose nanofibrils may be incorporated into known formulations for superabsorbent polymers, rheological modifiers, hydrophobic coatings, carriers for a drug delivery system (e.g. microbeads) or battery and wearable technologies.

More specifically, the resulting surface modified nanocellulose material can be a drop-in replacement (with improved functionality) for any known cellulose nanofibril or nanocrystal applications and also for synthetic products it seeks to replace, such as superabsorbent polymers including Carbopol® or synthetic films for battery and tech applications. As such, no modifications of known formulations are required when using the surface modified nanocellulose material of the present invention.

Also described is the use of the surface modified cellulose nanofibrils and surface modified cellulose nanocrystals in drug delivery systems, composites, oil and gas, paints, cosmetics, foods, coatings or films.

The features of one of the aspects of the present invention apply mutatis mutandis to the other aspects of the present invention.

### DETAILED DESCRIPTION

Embodiments of the present invention will now be described with reference to the following, non-limiting examples and figures.

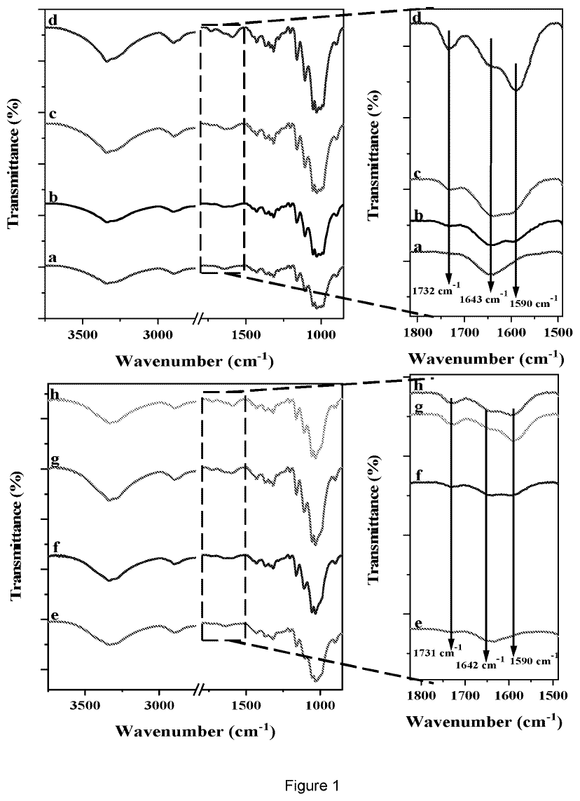

FIG. 1 illustrates infrared spectra of unmodified cellulose and cellulose modified with citric acid at various temperatures;

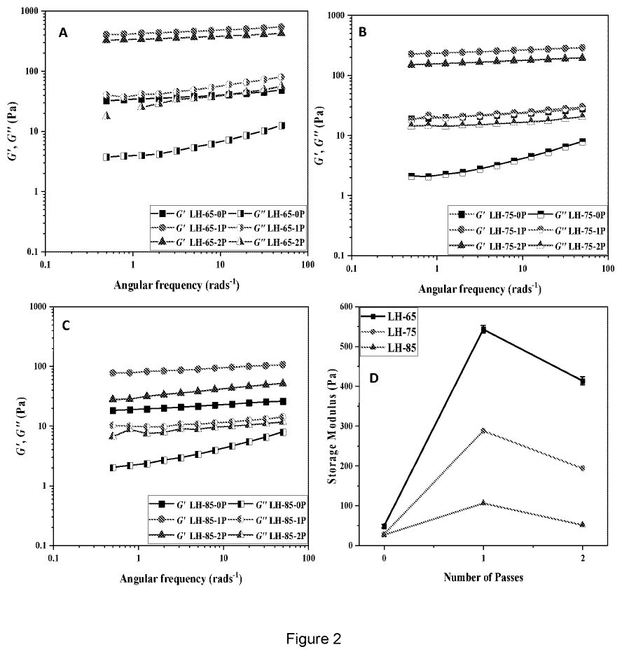

FIG. 2 illustrates frequency sweep rheograms of various samples of citric acid modified cellulose nanofibrils derived from Laminaria hyperborea seaweed and a summary of the storage modulus (G′) vs number of mechanical processing passes;

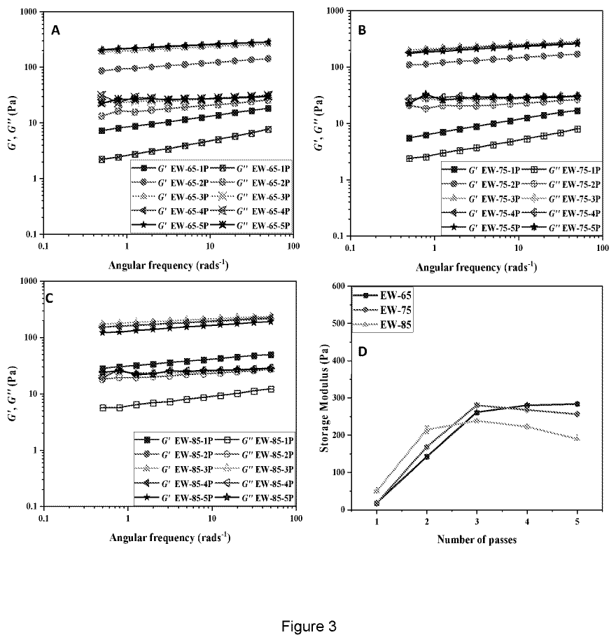

FIG. 3 illustrates frequency sweep rheograms of various samples of citric acid modified cellulose nanofibrils derived from Eucalyptus wood and a summary of the storage modulus (G′) vs number of mechanical processing passes;

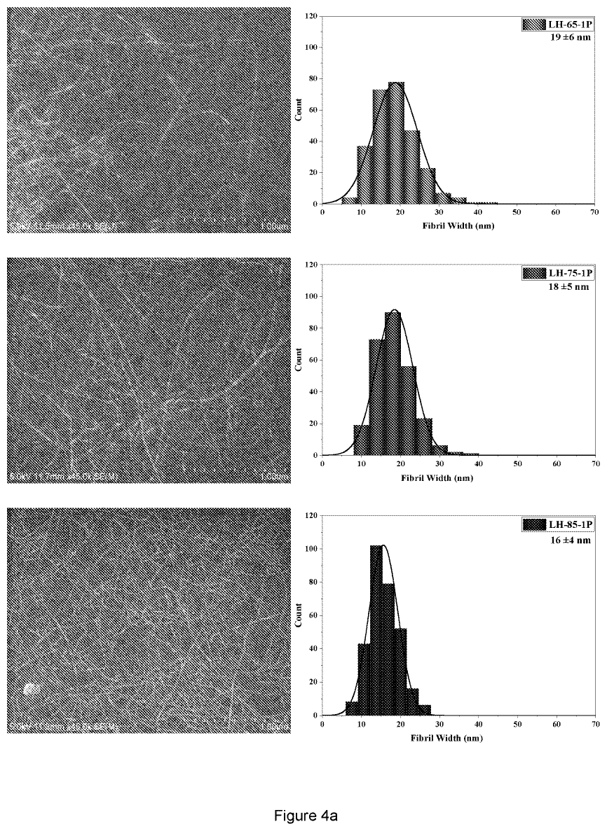

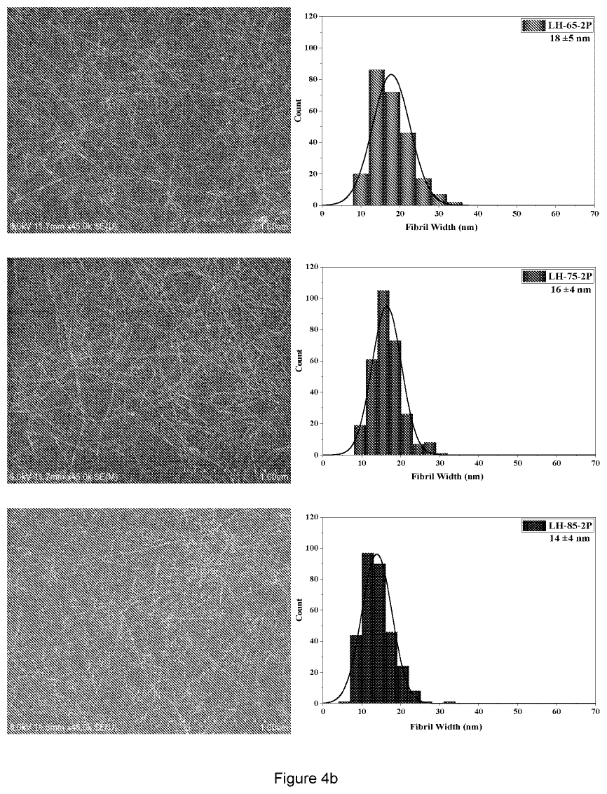

FIG. 4a illustrates FE-SEM micrographs and fibril width distributions of LH CACNFs prepared at various temperatures with a single pass through the homogeniser;

FIG. 4b illustrates FE-SEM micrographs and fibril with distributions of LH CACNFs prepared at various temperatures with two passes through the homogeniser;

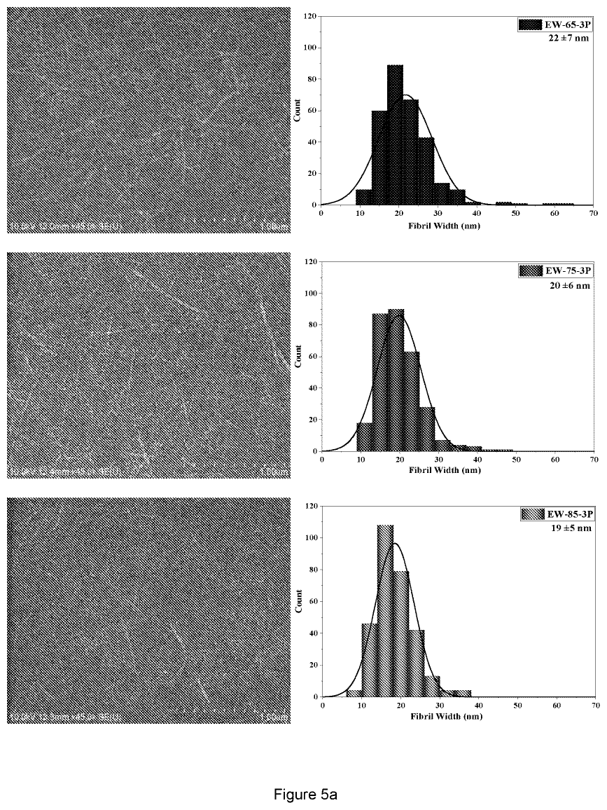

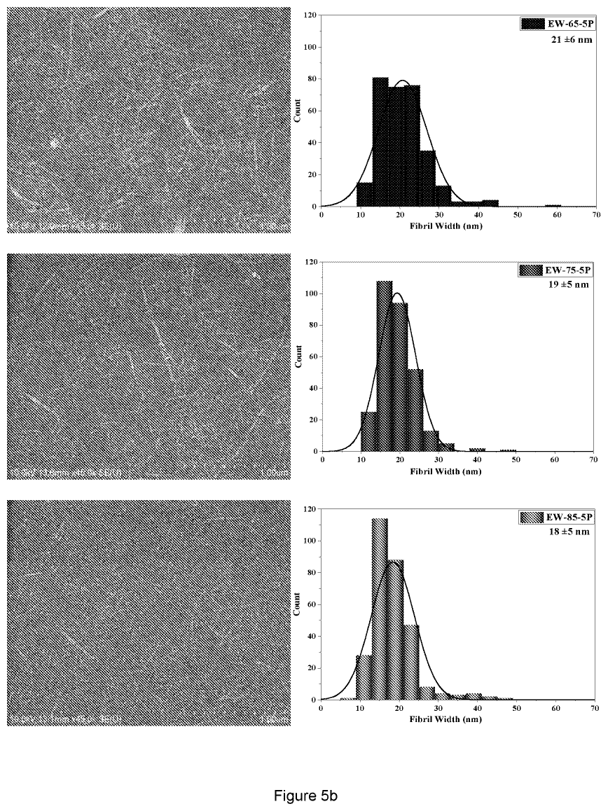

FIG. 5a illustrates FE-SEM micrographs and fibril width distributions of EW CACNFs prepared at various temperatures and three passes through the homogeniser;

FIG. 5b illustrates FE-SEM micrographs and fibril with distributions of EW CACNFs prepared at various temperatures and five passes through the homogeniser;

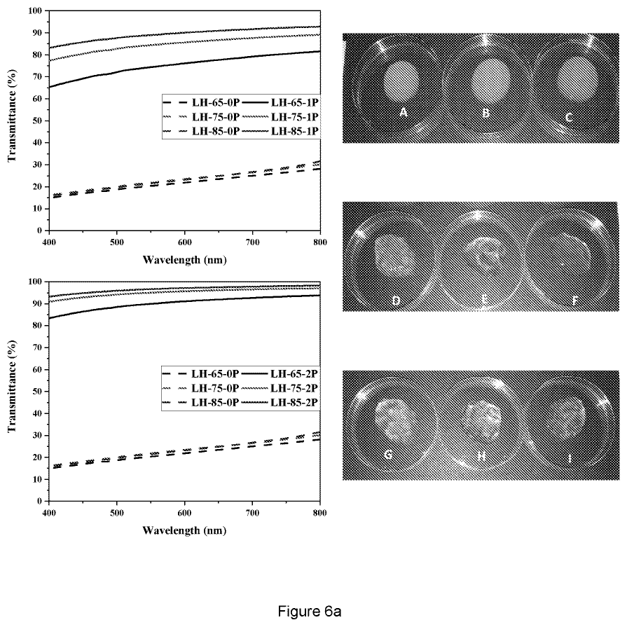

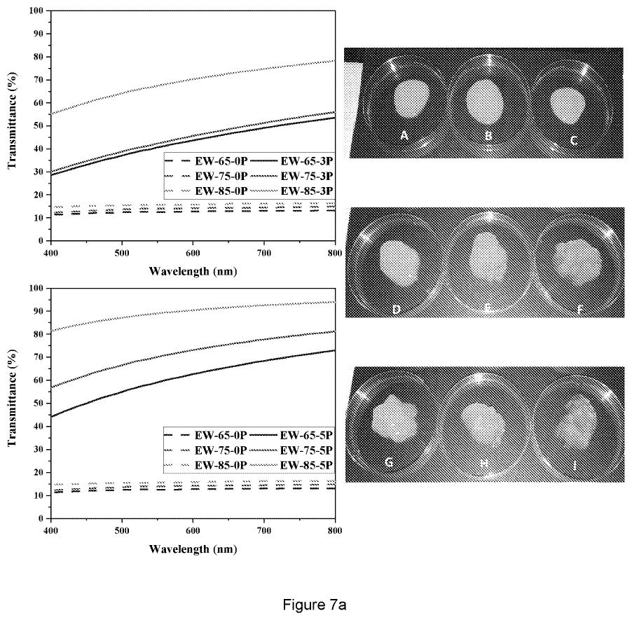

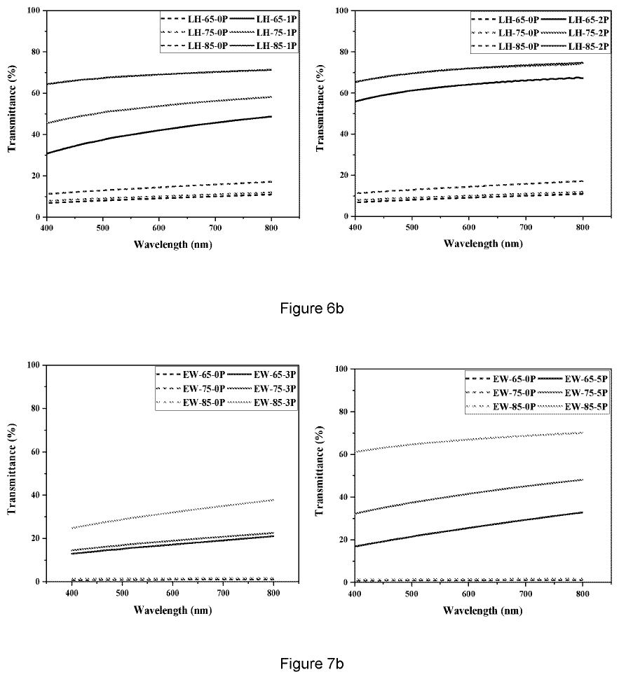

FIG. 6a illustrates spectra from UV-Vis analysis of 0.1 wt. % citric acid modified LH suspensions at different reaction temperatures and number of passes and photographic images of 1 wt. % suspensions;

FIG. 6b illustrate an overlay of spectra from UV-Vis analysis of citric acid modified LH films at various temperatures and two homogenisation steps;

FIG. 7a illustrates spectra from UV-Vis analysis of 0.1 wt. % citric acid modified EW suspensions at different reaction temperatures and number of passes and photographic images of 1 wt. % suspensions;

FIG. 7b illustrates an overlay of spectra from UV-Vis analysis of citric acid modified EW films at various temperatures and two homogenisation steps;

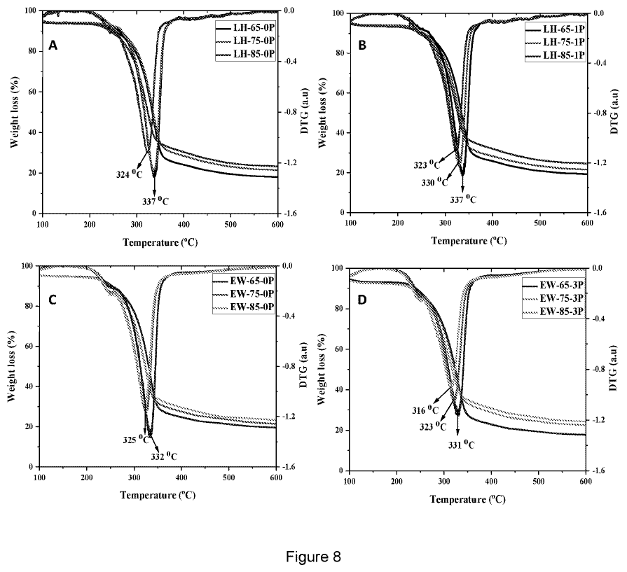

FIG. 8 illustrates TGA and DTG thermograms of citric acid modified LH cellulose before (A) and after mechanical processing (B) and that of EW cellulose before (C) and after mechanical processing (D);

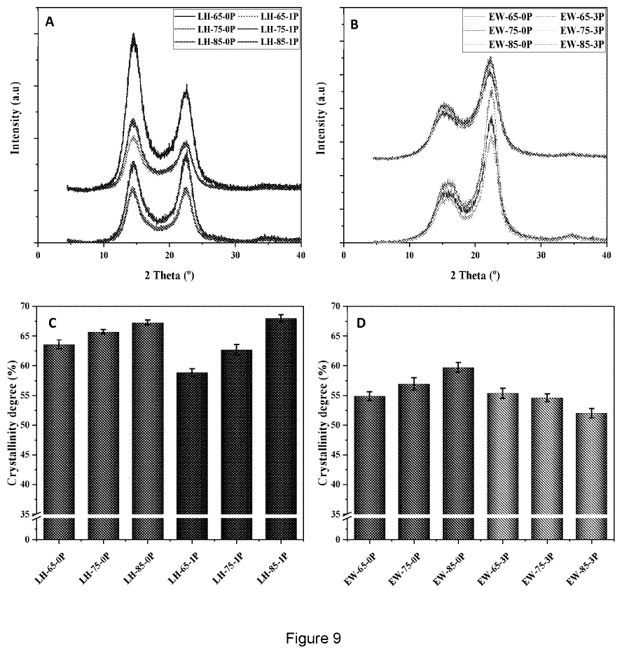

FIG. 9 illustrates diffractograms from modified and processed LH (A) and EW (B) samples and crystallinity indices of LH (C) and EW (D) cellulose; and

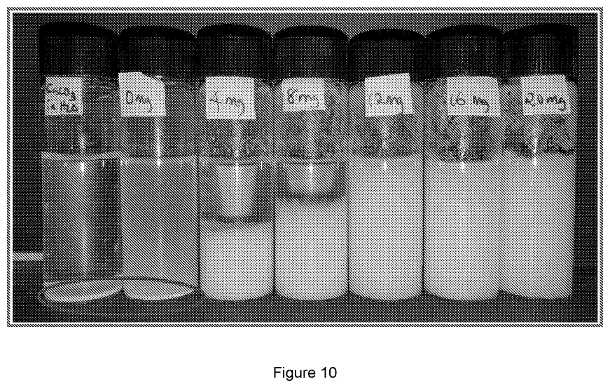

FIG. 10 illustrates photographic image of CaCO₃ particles suspended in sodium alginate solution by LH-85-1P at various amounts.

In the subsequent examples, surface modified CNFs were produced at lower temperatures using two cellulose sources from different cellulose crystalline allomorphs. Laminaria hyperborea cellulose contains a greater portion of cellulose la crystalline allomorph and has been recently harnessed for the production of high quality cellulose nanofibrils (Onyianta, A.J., O'Rourke, D., Sun, D. et al. High aspect ratio cellulose nanofibrils from macroalgae Laminaria hyperborea cellulose extract via a zero-waste low energy process. Cellulose 27, 7997-8010 (2020)). On the other hand, wood is the major source of cellulose for nanocellulose production, which contains a greater proportion of cellulose lβ crystalline allomorph.

These two cellulose sources were surface modified with citric acid at lower temperatures (less than 100° C.) and mechanically processed to varying degrees of fibrillation. The success of the modification is shown through surface chemistry analyses using Fourier transform infrared (FTIR) spectroscopy and conductometric analysis. The viscoelastic properties are studied to understand the effects of the citric acid modification at various reaction temperatures and degrees of processing on the storage modulus of the two cellulose sources. Subsequently, the effects of the citric acid modification at the various temperatures on the morphology, film transparency, thermal properties and percentage crystallinities of the two cellulose sources, before and after mechanical processing are fully studied. Finally, one of the potential applications of the citric acid modified CNF in stabilising insoluble particles and preventing them from sedimentation is demonstrated.

### Preparation of Raw Materials

Never dried cellulose (20 wt. %) and low viscosity sodium alginate (SA), both from Laminaria hyperborea (LH) seaweed, were supplied by Marine Biopolymers Ltd (Ayrshire, Scotland).

Never dried Eucalyptus wood (EW) pulp, 25 wt. %, was supplied by Sappi Ltd (Saiccor, South Africa).

Both cellulose pulps were concentrated in the oven at 50° C. for 30 minutes to attain a dry weight of 48-58 wt. % for subsequent processing.

### Surface Modification with Organic Acid and Mechanical Processing

Water was added to a 2 L oil jacketed reactor set at 99.50° C. using Julabo oil bath as required to achieve a final 80% solution of citric acid. This was followed with the gradual addition of citric acid (Fisher Scientific UK) under continuous stirring to make 4.2M solution, while also considering the residual water in the concentrated cellulose. After complete dissolution, the temperature of the oil bath was reduced to 65° C., 75° C. or 85° C.

Specific amounts of cellulose were added to the citric acid solutions to make 3.1 wt. % cellulose suspension. The reaction was subjected to stirring for 4 hours at 65° C., 75° C. and 85° C. for both LH cellulose and EW cellulose.

After 4 hours, the reaction was quenched by adding equal weight of water to the weight of the reaction mixture. The cellulose was washed 4 times with water by centrifugation before being dispersed in 0.5M sodium bicarbonate (Fisher Scientific UK) at 2 wt. % cellulose solid content. The cellulose-sodium bicarbonate dispersion was allowed to soak for 1 hour. The aim of this step was to convert the carboxylic acid groups to the sodium carboxylate form. After 1 hour, the cellulose was washed with water by centrifugation until a pH of 7.5 was attained.

1 wt. % aqueous dispersion was prepared for each sample and passed through the high-pressure homogeniser (PSI-20, Adaptive Instruments, UK) at 200 MPa, 2 times for the LH cellulose samples and 5 times for the EW cellulose samples.

Samples are hereafter named with the format: XY-00-0P, where XY represents the cellulose source (LH or EW), 00 represents the reaction temperature (65, 75 or 85° C.) and OP represents the number of passes through the high-pressure homogeniser (0-5 passes).

### Characterisation of Modified Cellulose

### Functional Group Characterisation

An ATR-FTIR spectrophotometer (Frontier, Perkin-Elmer, USA) equipped with a diamond crystal was used to determine the functional groups of the cellulose samples before and after the surface modification (without mechanical processing). The cellulose samples were dried into films before being used to obtain the spectra from 4000 cm⁻¹ to 500 cm⁻¹ at 4 cm⁻¹ resolution.

The infrared spectra of the unmodified LH and EW cellulose are presented in FIG. 1 alongside those of the citric acid modified celluloses. Infrared spectra of unmodified LH cellulose (a), LH-65-0P (b), LH-75-0P (c), LH-85-0P (d), unmodified EW cellulose (e), EW-65-0P (f), EW-75-0P (g), and EW-85-0P (h) are shown. The regions showing the effects of reaction temperature on functional groups are presented as magnified image.

All spectra show bands typical of cellulose material. These are the broad band at 3339 cm⁻¹ assigned to the different inter-and intra-molecular hydrogen bonds, the band at 2898 cm⁻¹ assigned to symmetric and asymmetric stretching vibration of C—H groups and the band at 1030 cm⁻¹ assigned to the C—O stretching vibrations.

The effect of the surface modification can be seen from the magnified image on the right side of FIG. 1. The bands at 1732(1) cm⁻¹, 1643(2) cm⁻¹, and 1590 cm⁻¹ are respectively assigned to the COO⁻ from the carboxylic acid groups, O—H stretching vibration from the adsorbed water molecules and the COONa from the sodium carboxylate groups converted after sodium bicarbonate treatment (Fujisawa, Okita, Fukuzumi, Saito, & Isogai, 2011; Spinella et al., 2016). The bands corresponding to COO⁻ and COONa groups are not present in the original LH cellulose and EW cellulose, indicating a successful surface modification process. The increase in reaction temperature led to an increase in the intensities of the carboxylic acid and sodium carboxylate groups for both cellulose sources, indicative of an increase in surface modification.

Conductometric titration was used to measure the total acidic groups content on the cellulose materials before and after the surface modification (without mechanical processing). The never dried cellulose and modified cellulose were dispersed in 0.1M HCl (Sigma-Aldrich, UK) for 15 minutes to protonate the acidic groups before titration. It was then washed thoroughly with water until the conductivity was below 5μS/cm. 0.3 g of the protonated cellulose was added to 147 ml of water having 3 ml of 0.05 M NaCl (Sigma-Aldrich, UK). The mixture was stirred for 30 minutes before being titrated with 0.05 M NaOH (Sigma-Aldrich, UK). The experiment was conducted three times and the average data reported. This conductometric titration method was adapted from the SCAN-CM 65:02, (2002) test known in the art.

Zeta potential measurements were carried out on the unmodified and modified samples that were dispersed in 5 mM NaCl (Sigma-Aldrich, UK) solution using Zetasizer Nano-ZS (Malvern, UK) with a DTS 1060 capillary cell. Measurements were carried out at the refractive index of water (1.33) and at a temperature of 25° C. 20 measurements were carried out per sample and 10 runs per measurement. The average result±standard deviation is reported.

The results of conductometric titration and zeta potential measurements for the samples are presented in Table 1 below, together with a reference control sample of carboxymethylated Eucalyptus wood. The reference control is produced by a standard technique for producing gel-like properties in nanocellulose for standard thickener applications.

| | Total | |
|---|---|---|
| | acidic | Zeta |
| | groups | Potential |
| Sample | (μmol/g) | (mV) |
| LH cellulose | 78 ± 1 | −24.5 ± 1.6 |
| LH-65-0P | 137 ± 2 | −37.1 ± 1.3 |
| LH-75-0P | 217 ± 6 | −39.7 ± 4.9 |
| LH-85-0P | 341 ± 4 | −42.2 ± 2.0 |
| EW cellulose | 30 ± 0 | −23.2 ± 1.6 |
| EW-65-0P | 182 ± 2 | −33.6 ± 1.7 |
| EW-75-0P | 280 ± 3 | −38.1.4 ± 1.7 |
| EW-85-0P | 429 ± 12 | −42.3 ± 2.1 |
| Carboxymethylated EW CNF | 550 ± 4 | — |
| (Onyianta et al 2018*) | | |

*Onyianta, A. J., Dorris, M., & Williams, R. L. (2018). Aqueous morpholine pre-treatment in cellulose nanofibril (CNF) production: comparison with carboxymethylation and TEMPO oxidisation pre-treatment methods. Cellulose, 25(2), 1047-1064

The surface charges of the two cellulose starting materials are different and result from possible residual alginate and hemicellulose from the seaweed and eucalyptus wood, respectively. The increase in reaction temperature (from 65° C. to 85° C.) resulted in an increase in total acidic groups and zeta potential values of LH and EW cellulose samples.

Citric acid modified sugarcane bagasse CNF prepared by Ji et al., (2019) with 80% citric acid at 100° C. and for 4 hours yielded a total surface group of 300 μmol/g. The study also highlighted the changes in total surface groups of CNCs/CNF as a result of increase in reaction time and citric acid concentration (Ji et al., 2019). The present invention further indicates that surface modification can be achieved at lower temperature and a 10° C. increase in reaction temperature leads to a significant increase in the total surface acidic groups of LH cellulose and EW cellulose. The amount of total surface groups of EW-85-0P is similar to the total surface charge obtained on the same cellulose source after carboxymethylation modification process (Onyianta at al, 2018). Therefore, it has surprisingly been shown that comparable surface modification can be achieved at lower temperatures and by more simplified methods.

### Linear Viscoelastic Measurements

Linear viscoelastic measurements were carried out using a serrated concentric cylinder geometry, having an inner diameter of 24 mm and outer diameter of 26 mm, attached on AR-G2 rheometer (TA Instruments, USA). These measurements were used to determine the effects of reaction temperatures and increasing number of passes on the storage modulus of the cellulose nanomaterials. Measurements were carried out on 1 wt. % citric acid modified samples.

The samples of citric acid (CA) modified cellulose nanofibrils (CNFs) from LH and EW cellulose were first subjected to a pre-shear regime at a shear rate of 100 s⁻¹ for 100 seconds to clear sample and loading history. They were then allowed to rest for 10 minutes through a time sweep at 50 rads⁻¹ and 0.1% strain. The frequency sweeps were carried out from 50 rads⁻¹ to 0.5 rads⁻¹ at a strain value (0.1%) that is within the linear viscoelastic region (LVR) for each sample as determined from the amplitude sweeps. Samples were tested in triplicates and the average data±standard deviation are reported.

The frequency sweeps from LH CACNF and EW CACNF at various citric acid modification temperatures and number of passes are overlaid and shown in FIGS. 2A to 2C and FIGS. 3A to 3C respectively.

The summary of changes in storage modulus (G′) vs number of mechanical processing are also presented in FIG. 2D and FIG. 3D for LH CACNF and EW CACNF respectively. Unprocessed suspensions of EW cellulose (EW-00-0P) could not be tested because the fibres sedimented within the minimum 30 minutes required for the rheological tests unlike LH cellulose counterpart which remained stabilised in suspension.

All the samples tested showed a higher storage modulus than loss modulus and a storage modulus that is relatively independent of angular frequency, showing a prevalent structured and gel-like material.

To fully analyse and understand the linear viscoelastic properties of the citric acid modified CNFs, the colloidal theory of Derjaguin, Landau, Vervey, and Overbeek (DLVO) shown in Equation 2 was used. The theory states that the total potential energy (VT) acting upon a material is the sum of all attractive forces (VA) and all repulsive forces (VR) (Boluk, Lahiji, Zhao, & McDermott, 2011). The gel-like and elastic nature of CNF aqueous suspensions result from the amalgamation of repulsive forces (total surface charge) and attractive forces, which arise from the intramolecular and intermolecular forces, leading to physical entanglements (Nechyporchuk, Belgacem, & Pignon, 2016).

$${V}_{T} = {V}_{A} + {V}_{R} \qquad Equation 2$$

The summary of results in FIG. 2D shows that the highest storage modulus is obtained with LH cellulose modified at 65° C. Increasing the reaction temperature to 85° C. led to a decrease in storage modulus, even though it has been shown earlier that increase in reaction temperature resulted to an increase in total ionic groups. This trend was also seen for EW CACNFs. This behaviour may be ascribed as an effect of reduced fibril length and entanglement.

For all the LH samples modified at different temperatures, a single pass through the high-pressure homogeniser appeared to have reduced the micron sized fibres to thinner nanosized network of fibrils with higher aspect ratios and an overall increase in storage modulus. The small amount of residual sodium alginate when hydrolysed by the high concentration of citric acid could possibly leave void spaces within the cellulose matrix, thereby easing the fibrillation of LH cellulose. A second pass however resulted in a decrease in storage modulus, which could be attributed to a reduction in the interconnectivity of the fibrils and physical entanglements. It can then be inferred that for the citric acid modified LH nanomaterials, the attractive forces play a major role in the elastic modulus properties.

The effects of the contributions from the attractive and repulsive forces on the storage modulus can be clearly seen with the citric acid modified EW CACNFs as shown in FIG. 3D. At lower number of passes (1-2 passes), the sample prepared at 85° C. and having a higher surface charge, showed the highest storage modulus. An indication that the repulsive forces are dominating for these samples. A crossover, however, occurred at the 3^{rd} pass and from the 4^{th} pass, samples prepared at 75° C. and 85° C. showed a decline in storage modulus compared to that prepared 65° C. This behaviour could be attributed to a possible reduction of fibril length and/or width.

Comparing the linear viscoelastic behaviour of LH CACNF with EW CACNF, the former possesses a higher storage modulus, especially at lower temperatures. This could be a result of the long fibril nature of LH cellulose. EW cellulose required a greater number of passes (3 passes) to reach the optimum storage modulus before a plateau or a decline was seen (FIG. 3D). The rheological properties of the citric acid modified CNFs also compare favourably with other anionic surface modified CNFs such as those from TEMPO-mediated oxidation and carboxymethylation. For example, in terms of the storage modulus, the nanocellulose product modified at 85° C. has been found to be comparable with TEMPO-modified CNF, while the nanocellulose product modified at 65° C. has found to be at least comparable with carboxymethylated CNF.

### Morphological Characterization

Scanning electron micrographs were acquired using S4800 FE-SEM, (Hitachi, Japan). Samples were homogenised and diluted to form 0.0001 wt. % solution before being dropped on a freshly cleaved mica disc that was attached on an FE-SEM aluminum stub. All samples were dried overnight at room temperature. The dried samples were gold coated for 90 seconds using a sputter coater (EMITECH K550X, Quorumtech, UK) and observed at 3 kV acceleration voltage. Up to 300 fibrils widths from not less than 5 images per sample were measured using ImageJ software.

Fibril morphology of the 1 pass LH CACNFs and those of 3 pass EW CACNFs prepared at various temperatures are shown in FIG. 4a and FIG. 5a, respectively. The morphology of the CACNFs with greater degree of processing for both LH and EW cellulose are respectively presented in FIG. 4b and FIG. 5b. The average fibril widths are inserted in the fibril width distribution plots.

These micrographs show that nanofibrils are present in all the samples that were prepared at various temperatures and processing degrees. Therefore, processing at higher number of passes would only be required to improve other material properties, such as transparency, and not essentially to produce nanofibrils.

The tricarboxylic acid modified LH CACNFs manifest as a web-like network of long, highly aggregated fibrils, which is consistent with the morphology of the unmodified LH cellulose nanofibrils. In contrast, modified EW CACNFs appear as shorter fibrils with reduced interconnectivity. Unmodified EW CNFs are inherently shorter in length. These morphologies explain the high storage moduli observed for LH samples compared to those of EW. The reduction in storage modulus with increased processing degree, which is thought to be arising from reduced fibril length, was however not observable within the SEM field of view for LH CACNFs.

The average fibril widths of all LH CACNFs are thinner than those of EW CACNFS, even though these samples have received lower degrees of processing. This shows the superiority of LH cellulose for CNF production. For the samples processed at any given number of passes, there appears to be a slight reduction in fibril width distribution with increase in reaction temperature for both LH (19±6 nm to 16±4 nm) and EW samples (22±7 nm to 19±5 nm). These changes in widths were not however considered significant. The overall fibril width range for all the samples was between 5 and 35 nm, with few larger fibrils between 40 and 60 nm.

The long and interconnected nature of the fibrils and the difficulty in identifying each ends of the fibrils could not allow the measurement of fibril length. Nonetheless, this is estimated to be in the order of several micrometres for LH CACNFs and much shorter for EW CACNFs.

### Transparency Measurement

Changes in transparency of the samples were tested. Suspensions were diluted to 0.1 wt. %, whereas films were casted at 0.4 wt. % in a petri dish and dried over laboratory fume hood for 48 hours. The films were then cut into strips of approximately 45 mm length and 12 mm width corresponding to the dimension of the quartz cuvette used in measurement. The strips were carefully attached to the cuvettes and measurements were taken from 800 nm to 400 nm in the transmission mode on Lambda750 UV/Vis/NIR spectrophotometer (Perkin Elmer, USA).

The suspension and film transparency of the respective citric acid modified LH and EW cellulose, at various reaction temperatures, before and after mechanical processing were investigated and the result shown in FIG. 6a and FIG. 7a for suspensions and FIGS. 6b and 7b of the supporting material for films; films were cast by pouring a suspension of the citric acid modified LH and EW cellulose onto a plate and air-dried. Photographic images of the 1 wt. % suspensions are also presented in FIG. 6a and FIG. 7a for visual assessments.

FIG. 6a shows an overlay of spectra from UV-Vis analysis of 0.1 wt. % citric acid modified LH suspensions at different reaction temperatures and number of passes. The photographic images of 1 wt. % suspensions are also presented as (A) LH-65-0P, (B) LH-75-0P (B), (C) LH-85-0P, (D) LH-65-1P, (E) LH-75-1P, (F) LH-85-1P, (G) LH-65-2P, (H) LH-75-2P and (I) LH-85-2P.

FIG. 7a shows an overlay of spectra from UV-Vis analysis of 0.1 wt. % citric acid modified EW suspensions at different reaction temperatures and number of passes. Photographic images of EW-65-0P (A), EW-75-0P (B), EW-85-0P (C), EW-65-3P (D), EW-75-3P (E) and EW-85-3P (F) at 1 wt. %.

Prior to mechanical processing, the effects of reaction temperatures on the transparency of modified LH and EW cellulose suspensions and films were insignificant. However, after a single pass (LH samples) or 3 passes (EW samples) through the high-pressure homogeniser, the effect of temperature and mechanical shearing on transparency can be seen from both the UV-vis spectra and the photographic images provided. The 1 wt. % suspensions transform to gel-like materials. There is an overall increase in transparency with increase in the reaction temperature, which directly correlates to increase in surface repulsive groups. The greater degree of fibrillation attained with a single pass of LH cellulose explains the higher transparency, compared to the EW CACNF which has received 3 passes through the high-pressure homogeniser.

Transparency is further increased after 2 passes for LH and 5 passes for EW samples. This increase may have arisen from the reduced fibril width and length (although not visible from SEM images), which ultimately would reduce aggregation and light scattering, allowing greater light to be transmitted through the film. The maximum respective transmittance that were attained at 600 nm were 97% and 90% for 0.1 wt. % LH-85-2P and EW-85-5P suspensions and 72% and 67% for LH-85-2P and EW-85-5P films. These values are very similar to the reported transparency (61-83% at 580 nm) of 0.35 wt. % carboxymethylated CNF film from various degrees of mechanical fibrillation (Siro, Plackett, Hedenqvist, Ankerfors, & Lindström, 2011).

Accordingly, it has been found that the transparency of the surface modified cellulose of the present invention is improved compared to wood derived CA modified CNF and is comparable to carboxymethylated CNF, which is an industry standard rheology modifier used for eye medication and other ophthalmic uses, i.e. when good transparency is required.

Transparency is an important attribute of the nanocellulose of the present invention as it is an indication of a homogeneous suspension of the nanocellulose. Nanomaterials are smaller than the wavelength of natural light and so should appear invisible i.e. provide a clear suspension or film. When the suspension or film is not clear, this means the material has aggregated or there is material present greater than nano-size. Therefore, transparency is an indication of product homogeneity. It also indicates the extent of surface charge, since a higher surface charge will repel the particles and prevent aggregation. Transparency improves appearance for applications such as films for food products, eye drop liquids etc.

### Thermal Stability Test

Thermogravimetric analyses (TGA) were conducted to determine the thermal behaviour of the carboxylated cellulose materials. TGA was carried out using Mettler Toledo TGA/DSC1 Star System (Mettler Toledo, Switzerland).

Approximately 10 mg of each sample was heated from 25° C. to 600° C. at a constant heating rate of 10° C./min under a constant nitrogen of 80 mL/min. DTG curves were obtained by performing a first derivative on the % weight loss data from TGA using OriginPro 2019 version.

It is highly desired that any beneficial chemical, biological or mechanical treatments of cellulose should not impact negatively on the thermal stability. Thermograms from thermogravimetric analysis (TGA) and derivative thermogravimetry (DTG), carried out before and after mechanical processing carboxylated LH and EW celluloses at various reaction temperatures are shown in FIG. 8.

FIG. 8 shows TGA and DTG thermograms of citric acid modified LH cellulose before (A) and after mechanical processing (B) and that of EW cellulose before (C) and after mechanical processing (D).

The onset decomposition temperatures, an average of 220° C., were not affected by changes in reaction temperature or mechanical processing. All surface modified LH and EW celluloses/CNFs showed two stages of decompositions that are identifiable from the DTG curves. An initial minor decomposition at 244-249° C. and a major decomposition at 316-337° C. The initial minor peaks depict the decomposition of sodium carboxylate and carboxylic acid groups, as also seen for TEMPO-mediated oxidised celluloses. However, the magnitude of decomposition compared to TEMPO-mediated oxidised celluloses is not as great because of the lower amount of surface charges obtained herein with the citric acid modification.

From the second decomposition peak, the thermal stability of LH cellulose modified at 65° C. and 75° C. were not negatively affected in comparison to unmodified samples. However, surface modification at 85° C. resulted in a peak decomposition temperature of 324° C. compared with 336° C. of unmodified LH cellulose. Accordingly, mechanical fibrillation did not adversely affect peak decomposition temperatures and therefore decomposition rates compared to other methods.

A similar trend was also observed for carboxylated EW cellulose, where a reduction in peak decomposition temperature was only seen for the sample prepared at 85° C. before mechanical processing. A slight decrease in temperature was seen for EW CACNF with increasing reaction temperature. Again, this decrease was not considered significant.

### Fibril Crystallinity

X-ray diffractograms were collected from modified samples before and after mechanical processing using Bruker D8 Advance X-ray diffractometer (Germany), having a Cu-Kα radiation (λ=0.1542 nm), a parallel beam with Gobel mirror and a Dynamic Scintillation detector. The accelerating voltage was of 40 kV, while the current was of 30 mA. The scanning range was between 5° and 40° (2θ).

The crystallinity degrees of the samples were calculated using the method proposed by Hermans & Weidinger, (1948) and widely used in the art. In order to do this, the X-ray diffractograms were deconvoluted using mixed Gaussian-Lorenzian profiles for the crystalline regions and Voight profile for the amorphous background. After deconvolution, the crystallinity degree was calculated using Equation 1.

$$Cr . I . \% = \frac{{A}_{cr}}{{A}_{t}} * 100 \qquad Equation 1$$

Here, Cr.I. % is the crystallinity degree, A_{cr} is the sum of signal areas (1-10), (110), (200), (102) and (004), and Aₜ is the total area under diffractogram.

The X-ray diffractograms are presented in FIG. 9A and FIG. 9B for modified LH and EW samples before and after mechanical processing. Both series of samples present the characteristic patterns for cellulose I signals at 2θ=14.3-14.8°, 16.3-16.6°, 20.3-20.6°, 22.3-22.5°, and 34.5-34.7° corresponding to the (1-10), (110), (102), (200) and (004) crystallographic planes.

The LH cellulose samples (FIG. 9A) present a shifting of the signal to 14.3° from 14.8° identified for the EW cellulose samples. At the same time, the signal intensity of the (200) crystallographic plane is very high compared to EW cellulose. This type of pattern was seen for unmodified LH cellulose, which is predominated with cellulose la allomorph. A similar pattern was also observed for the marine red algae Erythrocladia (Rhodophyta) cellulose that is shown to be rich in cellulose lα.

The calculated crystallinity indices of the modified LH and EW cellulose samples are shown in FIG. 9C and FIG. 9D respectively. There is an overall increase in crystallinity indices after citric acid modification in comparison to the unmodified LH (58±0.4) and EW cellulose (53±0.8). Both LH and EW celluloses also showed an increase in crystallinity degree with increase in the reaction temperature, possibly arising from the hydrolysis of residual non-cellulosic materials.

However, after mechanical processing of LH and EW cellulose samples, there was an overall decrease in crystallinity indices across the three reaction temperatures investigated, indicative of a non-selective break down of both ordered and amorphous regions of the cellulose chains, as is typical for cellulose processing. The percentage decrease in crystallinity indices across LH samples were between 4.6 to 7.5% and 4.2 to 13% for EW cellulose samples. The greater decrease in crystallinity indices of the EW samples may be attributed to a higher degree of mechanical shearing force (3 passes) needed to attain a structurally stable gel-like material, in comparison to LH cellulose which received less mechanical shearing force. Consequently, this is indicative of less aggregation and larger particles in the material processed in accordance with the present invention, wherein the mechanical energy is being used effectively to break down the fibrous cellulosic material to cellulose nanofibrils.

### Use of LH CACNF as Dispersant for Water Insoluble Calcium Carbonate Particles

The ability of CACNF to suspend calcium carbonate particles in low viscosity alginate suspension were evaluated using LH-85-1P and the method described below. This property is important in the formulation of personal care products and pharmaceutical products, which often have water insoluble active pharmaceutical ingredients (API). An example is in heartburn formulations which typically contain CaCO₃ and sodium alginate (SA) as API.

CaCO₃ was prepared by mixing aqueous solutions of sodium carbonate and calcium chloride. The calcium carbonate particles were thoroughly washed to remove the sodium chloride by product. 10 ml of 5 wt. % low viscosity SA, having various amounts (0 mg, 4 mg, 8 mg, 12 mg, 16 mg, and 20 mg) of LH-85-1P was added to 15 ml glass vials. A fixed amount of calcium carbonate (160 mg) was added to each glass vial and dispersed using Ultra Turrax at 10000 rpm for 3 minutes. Calcium carbonate was also dispersed in ultrapure water and SA alone as control samples. The dispersions were allowed to settle under gravity for 30 days before capturing photographs. Samples were prepared in triplicates.

A representative photographic image from the experiment is shown FIG. 10. CaCO₃ particles sedimented in water in less than 30 minutes, forming clear water and calcium carbonate phases. Few fine particles of the calcium carbonate were suspended in the low viscosity SA solution, whereas larger particles sedimented to the bottom of the vial, as circled in red.

CaCO₃ particles were uniformly suspended in the SA solution for all the various weight percentages of LH-85-1P. There appears to be some form of interaction between the sodium carboxylate groups of CACNF with the CaCO₃ particles, which prevented the formation of CaCO₃ bed at the bottom of the vial. Stable suspensions that did not phase separate are seen with the addition of 12 mg-20 mg of LH CACNF per 10 ml of SA/CaCO₃ suspension. It can be assumed that the increase in the amount of CACNF also increased the storage modulus of the suspension, leading to a more structured formulation that can withstand the incorporation of the CaCO₃.

This explains why the suspensions with 4 mg and 8 mg of LH-85-1P sedimented, forming two phases comprised of SA solution and SA/LH-85-1P/CaCO₃ suspension.

This result shows that CACNF can be used to effectively structure formulations and suspend insoluble APIs, such as CaCO₃. This offers a biobased and safer alternative to fossil fuel derived rheology modifiers, such as carbomer which is currently heavily relied upon by many industries.

It has been shown that the method of the present invention surprisingly provides a sustainable and cost efficient way of producing nanocellulose material with a high degree of surface modification, having at least comparable properties to those materials known in the art and which is suitable for use in a wide range of applications.

1. A method for producing surface modified nanocellulose material comprising:
i) providing a mixture of an organic acid and at least one solvent;
ii) providing a fibrous cellulosic material is an unprocessed form;
iii) suspending the fibrous cellulosic material in the mixture of the organic acid at a temperature of less than 100° C. to form a suspension;
iv) maintaining the suspension for a period of time to provide a surface modified fibrous cellulose material; and
v) passing the suspension through at least one chamber having a large gap, at a high shear to produce surface modified cellulose nanofibrils
wherein the organic acid is a dicarboxylic acid, a tricarboxylic acid or a mixture thereof.

2. The method of claim 1 further comprising:
washing the surface modified fibrous cellulose material in water after step (iv) to achieve a washed surface modified fibrous cellulose material with a neutral pH; and
suspending the surface modified fibrous cellulosic material in water to form a second suspension;
wherein the suspension passed through the at least one chamber in step (v) is the second suspension.

3. The method of claim 2 further comprising the steps of:
suspending the washed surface modified fibrous cellulose material in an alkali salt solution to form a further suspension;
maintaining the further suspension for a period of time; and
washing the surface modified fibrous cellulose material in water to achieve a neutral pH
prior to the step of suspending the surface modified fibrous cellulosic material in water to form the second suspension.

4. The method of claim 3, wherein the alkali salt of the alkali salt solution is sodium bicarbonate, sodium carbonate, sodium chloride, sodium hydroxide, potassium bicarbonate, potassium carbonate, potassium chloride, potassium hydroxide, or a mixture thereof.

5. The method of claim 3, wherein the alkali salt of the alkali salt solution is sodium bicarbonate.

6. The method of claim 3, wherein the further suspension is maintained for a period of 10 minutes to 5 hours.

7. The method of claim 1, wherein the fibrous cellulosic material is suspended in the mixture of the organic acid at a temperature within the range of from 65° C. to 85° C.

8. The method of claim 1, wherein the fibrous cellulosic material is suspended in the mixture of the organic acid at a temperature of less than 80° C.

9. The method of claim 1, wherein the organic acid is selected from the group consisting of oxalic acid, malic acid, malonic acid, succinic acid, tartaric acid, glutaric acid, citric acid, isocitric acid, aconitic acid, propane-1,2,3-tricaboxylic acid, agaric acid, trimesic acid or any combination thereof.

10. The method of claim 1, wherein the organic acid is citric acid.

11. The method of claim 1, wherein the organic acid is essentially soluble in the at least one solvent.

12. The method of claim 1, wherein the at least one solvent is water, methanol, ethanol, isopropanol, tert-butanol, isobutanol, butan-2-ol, acetone, dimethyl sulfoxide (DMSO), dimethylacetaminde (DMAC), dimethylformamide (DMF), or a mixture thereof.

13. The method of claim 1, wherein the mixture or organic acid and at least one solvent consists only of the organic acid and at least one solvent selected from water, methanol, ethanol, isopropanol, tert-butanol, isobutanol, butan-2-ol, acetone, dimethyl sulfoxide (DMSO), dimethylacetaminde (DMAC), dimethylformamide (DMF), or a mixture thereof.

14. The method of claim 1, wherein the suspension of step (iii) is maintained for a period of from 10 minutes to 10 hours.

15. The method of claim 1, wherein the fibrous cellulosic material is derived from algae, wood or water hyacinth.

16. The method of claim 1, wherein the surface modified fibrous cellulosic material is suspended in water at a concentration of from 0.5 to 5% by weight.

17. The method of claim 1, wherein the at least one chamber has a gap of 70 micron to 250 microns.

18. The method of claim 1, wherein the suspension undergoes from 1 to 7 passes through the at least one chamber having a large gap, at a high shear.

19. The method of claim 1, wherein the suspension is passed through the at least one chamber at a pressure up to 200 MPa.

20. The method of claim 1, further comprising the step of drying the surface modified cellulose nanofibrils.

21. The method of claim 1, further comprising the step of subjecting the cellulose nanofibrils to acid hydrolysis to form cellulose nanocrystals.

22. Cellulose nanofibrils having greater than 60% surface modification of active groups.

23. The cellulose nanofibrils of claim 22 having one or more of:
a. a fibril width of from 4 to 100 nm;
b. a fibril aspect ratio of greater than 50;
c. a fibril length of at least 750 nm to greater than 1 mm;
d. a storage modulus of 100 to 2000 Pa; and
e. a transparency of greater than 70% at 600 nm.

24. The cellulose nanofibrils of claim 22 having one or more of:
a. a fibril width of from 15 to 25 nm;
b. a fibril aspect ratio of greater than 100;
c. a fibril length of at least 750 nm to greater than 1 mm;
d. a storage modulus of 300 to 1800 Pa; and
e. a transparency of greater than 80% at 600 nm.

25. Surface modified cellulose nanofibrils formed by the method of:
providing a mixture of an organic acid and at least one solvent;
providing a fibrous cellulosic material is an unprocessed form;
suspending the fibrous cellulosic material in the mixture of the organic acid at a temperature of less than 100° C. to form a suspension;
maintaining the suspension for a period of time to provide a surface modified fibrous cellulose material; and
passing the suspension through at least one chamber having a large gap, at a high shear to produce surface modified cellulose nanofibrils,
wherein the organic acid is a dicarboxylic acid, a tricarboxylic acid or a mixture thereof.

26. Surface modified cellulose nanocrystals formed by the method of:
providing a mixture of an organic acid and at least one solvent;
providing a fibrous cellulosic material is an unprocessed form;
suspending the fibrous cellulosic material in the mixture of the organic acid at a temperature of less than 100° C. to form a suspension;
maintaining the suspension for a period of time to provide a surface modified fibrous cellulose material; and
passing the suspension through at least one chamber having a large gap, at a high shear to produce surface modified cellulose nanofibrils,
wherein the organic acid is a dicarboxylic acid, a tricarboxylic acid or a mixture thereof.

27. A superabsorbent polymer comprising at least one of cellulose nanofibrils having greater than 60% surface modification of active groups and the cellulose nanocrystals of claim 26.

28. A hydrophobic coating comprising at least one of the cellulose nanofibrils having greater than 60% surface modification of active groups and the cellulose nanocrystals of claim 26.

29. A carrier for a drug delivery system comprising at least one of the cellulose nanofibrils having greater than 60% surface modification of active groups and the cellulose nanocrystals of claim 26.

30. Use of the cellulose nanofibrils having greater than 60% surface modification of active groups in drug delivery systems, composites, oil and gas, paints, cosmetics, foods, coatings or films.

31. Use of the cellulose nanocrystals of claim 26 in drug delivery systems, composites, oil and gas, paints, cosmetics, foods, coatings or films.
